(19) United States
(12) Patent Application Publication
(10) Pub. No.: US 2020/0001476 A1
(43) Pub. Date: Jan. 2, 2020

(54) AXIS LOCK KNIFE WITH BALL BEARINGS

(71) Applicant: Utica Cutlery Company, Utica, NY (US)

(72) Inventors: David S. Allen, New Hartford, NY (US); Roy A. Gonzalez, Marcy, NY (US); William C. Harris, Rome, NY (US)

(21) Appl. No.: 16/442,840

(22) Filed: Jun. 17, 2019

Related U.S. Application Data
(60) Provisional application No. 62/690,392, filed on Jun. 27, 2018.

(51) Int. Cl. B26B 1/04

(52) U.S. Cl. CPC B26B 1/048

(57) ABSTRACT

A folding knife includes a blade having a tang. The tang has a cylindrical wall defining a pivot hole. A bearing counter bore pocket is disposed in at least one side of the tang. At least one bearing is disposed in the bearing counter bore pocket. An axis lock pin is slidingly mounted within slots in either side of a handle. At least one axis lock spring applies a spring bias between the handle and the axis lock pin, pressing the axis lock pin against an outside edge of the tang to transmit a force of the spring bias to the bearing perpendicular to a blade pivot axis to set a manual blade opening force.

### CROSS-REFERENCE TO RELATED APPLICATIONS

This application claims priority to and the benefit of co-pending U.S. provisional patent application Ser. No. 62/690,392, AXIS LOCK KNIFE WITH BALL BEARINGS, Jun. 27, 2018, which application is incorporated herein by reference in its entirety.

### FIELD OF THE APPLICATION

The application relates to a knife, more particularly to a folding knife.

### BACKGROUND

A pocket knife which can be opened by a one-handed operation is highly desirable. While a low friction blade open operation can be helpful, the blade should also not freely open under the force of gravity alone.

### SUMMARY

According to one aspect, a folding knife includes a blade having a tang. The tang has a cylindrical wall defining a pivot hole. A bearing counter bore pocket is disposed in at least one side of the tang. At least one bearing is disposed in the bearing counter bore pocket. An axis lock pin is slidingly mounted within slots in either side of a handle. At least one axis lock spring applies a spring bias between the handle and the axis lock pin, pressing the axis lock pin against an outside edge of the tang to transmit a force of the spring bias to the bearing perpendicular to a blade pivot axis to set a manual blade opening force.

In one embodiment, the axis lock pin includes a thumb bob on at least one end.

In another embodiment, the axis lock pin includes a spring slot or a spring notch to rotatingly couple said axis lock pin to the at least one axis lock spring.

In yet another embodiment, the spring slot is defined by a pair of washers set on at least one end of the axis lock pin.

In yet another embodiment, the handle includes a mark side handle, a mark side liner, and file side liner, and a file side handle.

In yet another embodiment, the at least one axis lock spring is slidingly disposed within an axis lock spring cavity of at least one of either the mark side handle or the file side handle.

In yet another embodiment, the at least one axis lock spring includes about a circular shape between a first end and a second end.

In yet another embodiment, the at least one axis lock spring includes a cup end.

In yet another embodiment, the at least one axis lock spring includes a right-angle pin end.

In yet another embodiment, the right-angle pin end is rotatingly disposed in a hole in at least one of either of a mark side liner or a file side liner.

In yet another embodiment, the right-angle pin end is rotatingly disposed in an opening extending from an axis lock pin slot in at least one of either of a mark side liner or a file side liner.

In yet another embodiment, the bearing includes a plurality of balls and a ball bearing race or a ball bearing frame.

In yet another embodiment, at least one of either a mark side liner or a file side liner includes a counter bore bearing pocket.

In yet another embodiment, the tang includes a flipper.

In yet another embodiment, an edge of the tang includes a notch.

In yet another embodiment, an edge of the tang includes an arcuate edge.

In yet another embodiment, an edge of the tang includes a first flat having a surface about aligned with a longitudinal axis of the blade.

In yet another embodiment, an edge of the tang includes a second flat having a surface about perpendicular to a longitudinal axis of the blade.

In yet another embodiment, a blade stop pin is disposed on the second flat about parallel to a pivot axis of the blade.

The foregoing and other aspects, features, and advantages of the application will become more apparent from the following description and from the claims.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A shows a drawing of an exploded view of an exemplary folding knife according to the Application;

FIG. 1B shows a detailed drawing of the features of the tang of the folding knife of FIG. 1A;

FIG. 1C shows another detailed drawing of the features of the tang of the folding knife of FIG. 1A;

FIG. 1D shows a detailed drawing of the axis lock pin of the folding knife of FIG. 1A;

FIG. 1E shows a detailed drawing of the axis lock spring of the folding knife of FIG. 1A;

FIG. 2 shows a detailed drawing of the spring biased axis lock pin acting against the outside edge of the tang of the folding knife of FIG. 1A;

FIG. 3 shows a drawing of a side view of the folding knife of FIG. 1A with the blade folded;

FIG. 4A shows a drawing of a file side view of the folding knife of FIG. 1A with the blade open;

FIG. 4B shows a drawing of a top view of the folding knife of FIG. 4A;

FIG. 4C shows a drawing of mark side view of the folding knife of FIG. 4A;

FIG. 4D shows a drawing of a bottom view of the folding knife of FIG. 4A;

FIG. 4E shows a drawing of an end view of the folding knife of FIG. 4A;

FIG. 5A shows a drawing of mark side isometric view of the folding knife of FIG. 4A; and

FIG. 5B shows a drawing of file side isometric view of the folding knife of FIG. 4A.

### DETAILED DESCRIPTION

A pocket knife which can be opened by a one-handed operation is highly desirable. While a low friction blade open operation can be helpful, the blade should also not freely open under the force of gravity alone. For example, if the blade were to open too easily, there could be accidental or inadvertent blade openings.

Some pocket knives have used one or two ball bearings for a low friction blade rotation. However, in prior art implementations, it can be difficult to effectively and repeatably set the blade opening force. While tightening the sides of the handle against the sides of the ball bearing can be short-term effective, the opening force typically becomes smaller, as the bearings and bearing race wears over time. Without a way to effectively and accurately set the opening force, mass produced bearing based pocket knives can either open too easily or open with an inconsistent opening force.

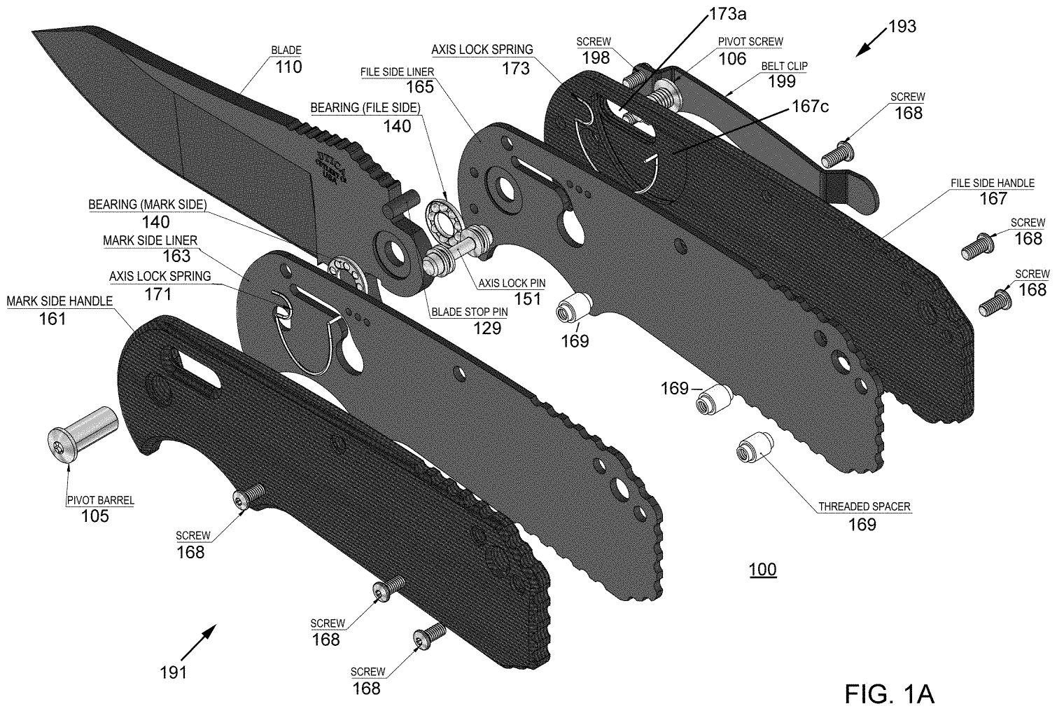

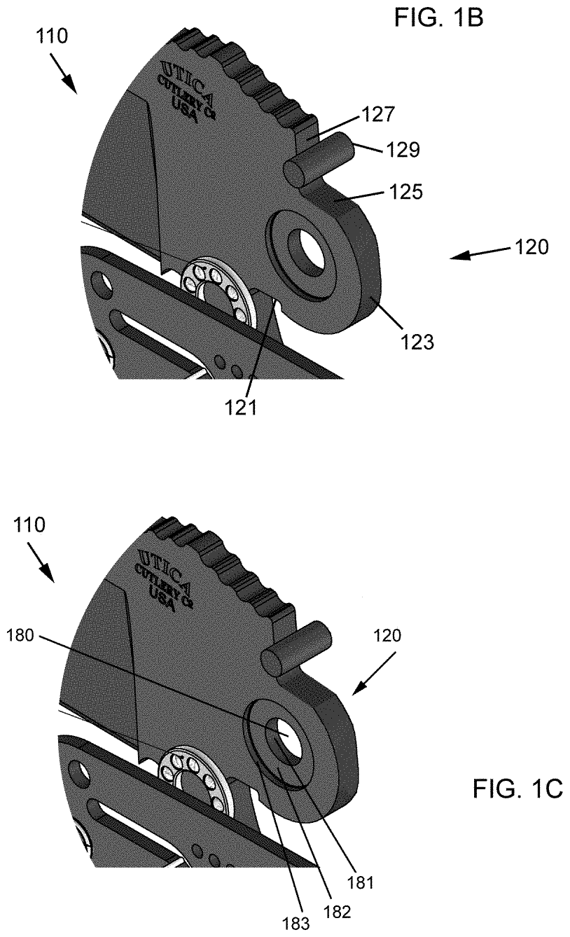

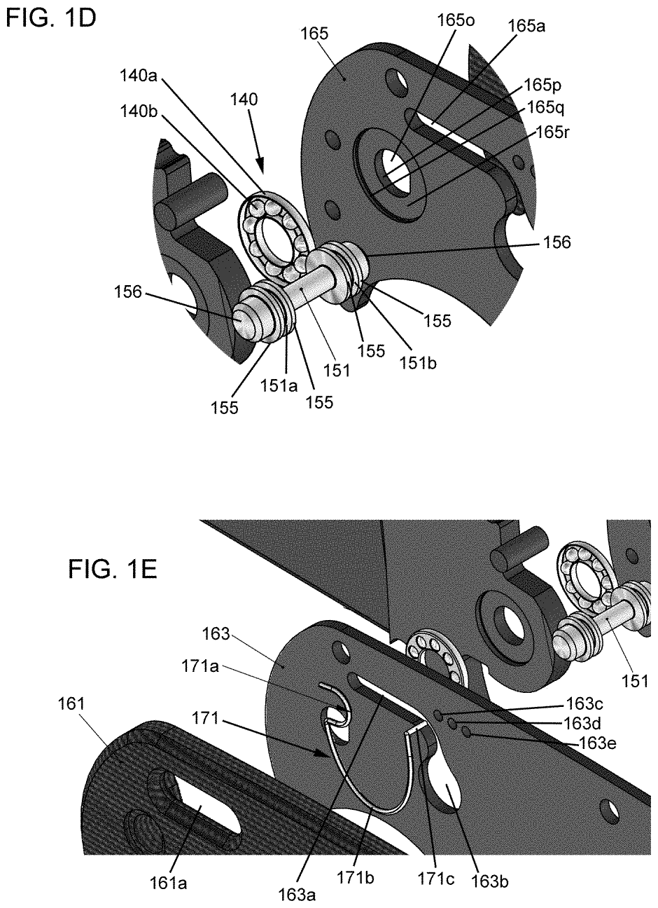

It was realized that by combining an axis lock pin with a ball bearing folding knife, the opening force can be reliably and consistently set during production. Also, where the axis lock pin is driven by springs, the opening force can remain substantially constant over time. Some of the reduction in opening force by the wear of rotating parts including the bearings and bearing race is compensated for by the available spring tension acting to spring bias the axis lock pin against the blade tang. Rather than control the ball bearing based blade opening force by tightening the handles to provide a compression force perpendicular to the plane of the ball bearing, it was further realized that the blade opening force can be more reliably and consistently set during production by a spring biased axis pin pushing against the outer edge of the blade tang. Where, for example, one side of a ball bearing (e.g. race, balls, or one half a split double race ball bearing) is embedded into a bore hole bearing pocket in at one side of the blade tang (both sides in the exemplary embodiment of FIG. 1A), the force exerted by the axis lock pin on the edge of the blade tang causes some friction and also pushes against the outer edge of the ball bearing race or casing to provide a repeatable manual blade opening force. This blade opening force can be so set repeatably and accurately at the time of knife production. Thus, the frictional force is controlled by a force applied to the outer edge of the ball bearings, perpendicular to the pivot (typically a pivot barrel) about which the blade rotates to open or close. Because of the spring bias on the axis lock pin, the opening force can remain substantially the same over long periods of time.

FIG. 1A shows an exploded view of an exemplary folding knife 100 according to the Application. The exploded view is shown looking from the mark side 191 of the folding knife towards the file side 193. Blade 110 can have any suitable cutting blade features, such as for example, any suitable blade length, blade width, point, swedge, cutting edge, and bevel. Such cutting blade features are unimportant to new structure of the blade opening ball bearings tensioned by a spring biased transverse axis lock pin acting against an outer edge of blade tang 120.

The folding knife 100 includes a mark side handle 161, mark side liner 163, file side liner 165, and file side handle 167. In the exemplary folding knife 100, the internal space for the folded blade is defined by threaded spacers 169, where screws 168 mechanically couple the handle parts into an assembled handle. The exact means to mechanically couple the handle parts into an assembled handle is unimportant to the new structure of the blade opening ball bearings tensioned by a spring biased transverse axis lock pin acting against an outer edge of blade tang.

Optional belt clip 199 can be secured to handle 173 by screws 198.

FIG. 1B shows a detailed drawing of the features of the tang of the folding knife of FIG. 1A. Blade tang 120 includes a notch 121, an outer arcuate edge 123, and a flat 125. A blade stop pin 129 can be affixed to an outer edge of the tang 120 about adjacent to the flat 125, such as to an about flat section 127 of the outer edge of the tang about perpendicular to the flat 125. The exemplary blade stop pin 129 has a blade stop pin long axis about perpendicular to the long axis of the blade 110.

FIG. 1C shows another detailed drawing of the features of the tang of the folding knife of FIG. 1A. Pivot barrel 105 extends through tang hole 180 as well as corresponding holes in mark side handle 161, mark side liner 163, file side liner 165, and file side handle 167. Tang hole 180 is defined by the tang pivot hole cylindrical wall 181. Exemplary pivot barrel 105 includes a female thread which accepts the male threaded bolt end of pivot screw 106. Both of pivot barrel 105 and pivot screw 106 have any suitable shaped head to capture and apply a closing force to the mark side handle 161 and file side handle 168 respectively. Tang counter bore bearing pocket 182 is further defined by the interior cylindrical wall 183.

FIG. 1D shows a detailed drawing of the axis lock pin of the folding knife of FIG. 1A. The axis lock pin 151 slides within the handle towards the blade 110 within slots 161a, 163a, 165a, and 167a. On either side of the axis lock pin there are spring slots 151a, 151b, notches, or troughs to accept and hold in position one end of an axis lock pin spring 171, 173. Spring cup ends 171a, 173a show an exemplary end spring shape for coupling between first end of each axis lock pin spring 171, 173, and each spring slot 151a, 151b of the axis lock pin 151. It is unimportant how each spring notch or spring slot is established on either side of the axis lock pin 151, here by two washers 155 on either side of the axis lock pin 151. Also, on either end of the axis lock pin 151, there are typically thumb studs 156 which protrude through handle axis lock pin slots 161a, 173a.

The bearing (e.g. ball bearing 140) typically includes a plurality of balls 140b and a bearing race or bearing frame 140a.

Liner counter bore bearing pocket 165r is further defined by the interior cylindrical wall 165q. Liner hole 165o accepts pivot barrel 105 which is secured by pivot screw 106. Note that in the exemplary folding knife of FIG. 1A, pivot barrel 105 includes an optional flat which matches the flat of liner hole 165o.

FIG. 1E shows a detailed drawing of the axis lock spring of the folding knife of FIG. 1A. The second ends 171c, 173c of the axis lock pin spring 171, 173 are typically rotatingly coupled either a cutout 163b, 165b in the liner, or to any suitable hole 163c, 163d, 163e, 165c, 165d, 165e in the liners 163, 165. Where there are a series of holes 163c, 163d, 163e, 165c, 165d, 165e in the liners 163, 165 placing the second end (typically a pin 171b, 173b made by about a right-angle bend (e.g. a right-angle pin end) in the second end of each of the axis lock pin springs 171, 173, one of the liner cutout openings or holes. The axis lock pin springs 171, 173 are free to move within cavities 161c (similar or identical to cavity 167c, cavity 161c not visible in FIG. 1A), 167c which can be cutout portions of the interior sides of handles 161, 167. Such cavities in handles are well known to those skilled in the art and can be provided by any suitable manufacturing means, such as, for example, by molding, machining, milling, etc.

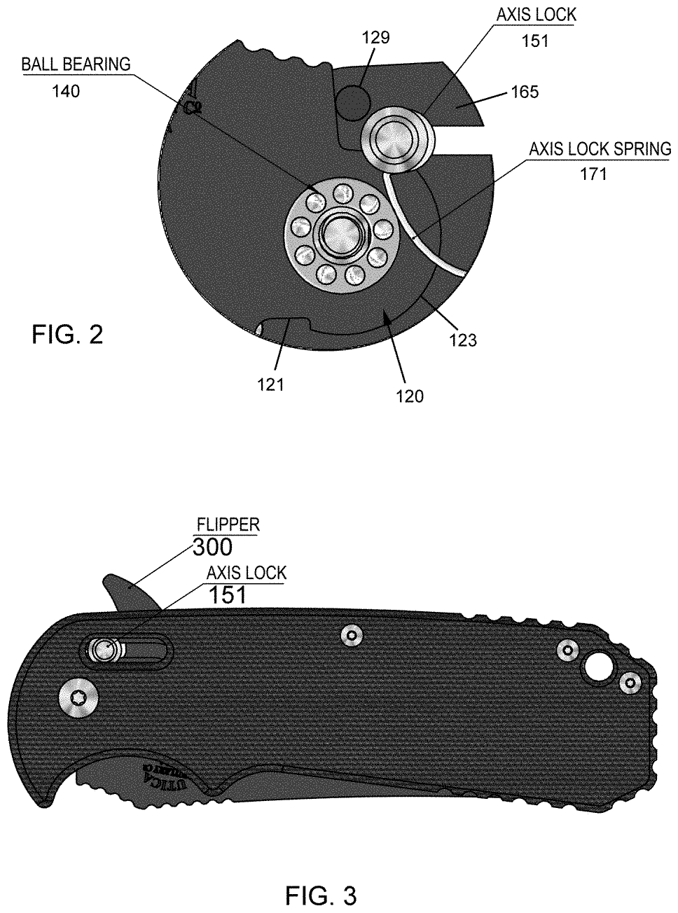

FIG. 2 shows a detailed drawing of the spring biased axis lock pin acting against the outside edge of the tang of the folding knife of FIG. 1A.

FIG. 3 shows a drawing of a side view of the folding knife of FIG. 1A with the blade folded.

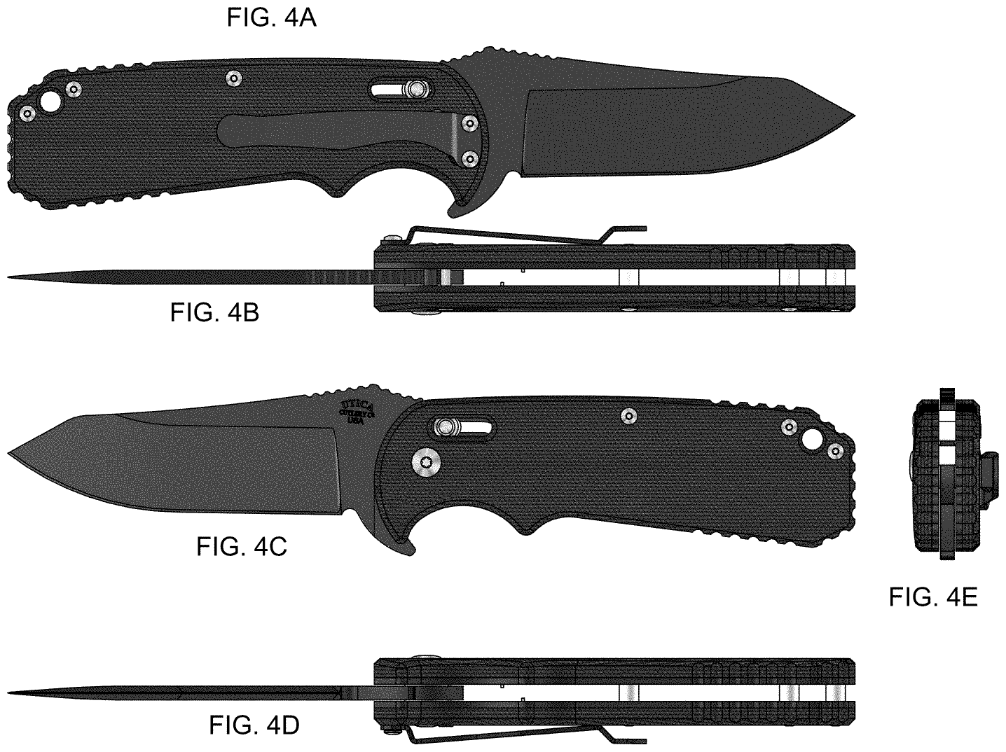

FIG. 4A shows a drawing of a file side view of the folding knife of FIG. 1A with the blade open.

FIG. 4B shows a drawing of a top view of the folding knife of FIG. 4A. FIG. 4C shows a drawing of mark side view of the folding knife of FIG. 4A. FIG. 4D shows a drawing of a bottom view of the folding knife of FIG. 4A. FIG. 4E shows a drawing of an end view of the folding knife of FIG. 4A.

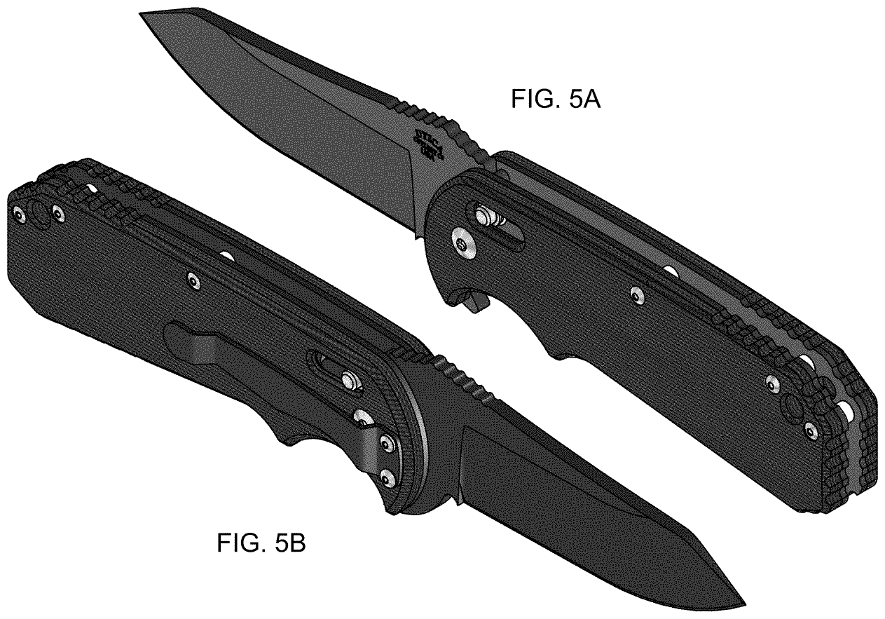

FIG. 5A shows a drawing of mark side isometric view of the folding knife of FIG. 4A.

FIG. 5B shows a drawing of file side isometric view of the folding knife of FIG. 4A.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A folding knife comprising:
a blade comprises a tang having a cylindrical wall defining a pivot hole, and a bearing counter bore pocket disposed in at least one side of said tang;
at least one bearing disposed in said bearing counter bore pocket;
an axis lock pin slidingly mounted within slots in either side of a handle; and
at least one axis lock spring to apply a spring bias between said handle and said axis lock pin, pressing said axis lock pin against an outside edge of said tang to transmit a force of said spring bias to said bearing perpendicular to a blade pivot axis to set a manual blade opening force.

2. The folding knife of claim 1, wherein said axis lock pin comprises a thumb bob on at least one end.

3. The folding knife of claim 1, wherein said axis lock pin comprises a spring slot or a spring notch to rotatingly couple said axis lock pin to said at least one axis lock spring.

4. The folding knife of claim 3, wherein said spring slot is defined by a pair of washers set on at least one end of said axis lock pin.

5. The folding knife of claim 1, wherein said handle comprises a mark side handle, a mark side liner, and file side liner, and a file side handle.

6. The folding knife of claim 5, wherein said at least one axis lock spring is slidingly disposed within an axis lock spring cavity of at least one of either said mark side handle or said file side handle.

7. The folding knife of claim 1, wherein said at least one axis lock spring comprises about a circular shape between a first end and a second end.

8. The folding knife of claim 1, wherein said at least one axis lock spring comprises a cup end.

9. The folding knife of claim 1, wherein said at least one axis lock spring comprises a right-angle pin end.

10. The folding knife of claim 9, wherein said right-angle pin end is rotatingly disposed in a hole in at least one of either of a mark side liner or a file side liner.

11. The folding knife of claim 9, wherein said right-angle pin end is rotatingly disposed in an opening extending from an axis lock pin slot in at least one of either of a mark side liner or a file side liner.

12. The folding knife of claim 1, wherein said bearing comprises a plurality of balls and a ball bearing race or a ball bearing frame.

13. The folding knife of claim 1, wherein at least one of either a mark side liner or a file side liner comprises a counter bore bearing pocket.

14. The folding knife of claim 1, wherein said tang comprises a flipper.

15. The folding knife of claim 1, wherein an edge of said tang comprises a notch.

16. The folding knife of claim 1, wherein an edge of said tang comprises an arcuate edge.

17. The folding knife of claim 1, wherein an edge of said tang comprises a first flat having a surface about aligned with a longitudinal axis of said blade.

18. The folding knife of claim 1, wherein an edge of said tang comprises a second flat having a surface about perpendicular to a longitudinal axis of said blade.

19. The folding knife of claim 18, wherein a blade stop pin is disposed on said second flat about parallel to a pivot axis of said blade.
